(19) United States
(12) Patent Application Publication
(10) Pub. No.: US 2006/0090015 A1
(43) Pub. Date: Apr. 27, 2006

(54) Pipelined circuit for tag availability with multi-threaded direct memory access (DMA) activity

(76) Inventor: Travis A. Bradfield, Colorado Springs, CO (US)

Correspondence Address: LSI LOGIC CORPORATION, 1621 BARBER LANE, MS: D-106, MILPITAS, CA, 95035, US

(21) Appl. No.: 10/973,479

(22) Filed: Oct. 26, 2004

(51) Int. Cl. G06F 13/28

(52) U.S. Cl. 710/22

(57) ABSTRACT

A method and system for determining multi-thread direct memory activity is described. A pipelined circuit for tag availability with multi-threaded direct memory access activity may be employed. The pipelined circuit includes registers for providing a tag to a direct memory access (DMA) thread and receiving the tag upon completion of the DMA thread. The DMA engine is implemented in a multi-threaded environment allowing for out of order completion of the data transfer requests, such as an environment including a peripheral component interconnect extended (PCI-X) bus. The pipelined circuit provides a multi-threaded DMA engine with tags for transactions. In this manner, the number of DMA threads created and executed by the DMA engine may not exceed the number of stages in the pipelined circuit.

### FIELD OF THE INVENTION

The present invention generally relates to the field of direct memory access, and more particularly to a pipelined circuit for tag availability with multi-threaded direct memory access activity.

### BACKGROUND OF THE INVENTION

Direct memory access (DMA) is a technique for transferring data from a main memory device to another device (or vice versa) without requiring the direct action of a central processing unit (CPU). Typically, DMA is performed in a single-threaded environment, wherein a first request for a block of memory data is handled before a second request is executed. However, data throughput may be significantly increased in a multi-threaded environment, where multiple threads are executed for handling data transfer at a given time.

In order to increase efficiency and maximize data throughput, the availability of the multi-thread system and the availability of particular threads is necessary. Consequently, it would be advantageous to provide on-demand access to individual DMA threads.

### SUMMARY OF THE INVENTION

Accordingly, the present invention is directed to a determining availability in multi-threaded direct memory access activity. In an embodiment of the invention, a pipelined circuit for tag availability with multi-threaded direct memory access activity. The pipelined circuit may include registers for providing a tag to a direct memory access (DMA) thread and receiving the tag upon completion of the DMA thread. For instance, a DMA engine executed in a multi-threaded DMA environment may generate multiple transfer requests (threads), process them in any order, and then reassemble the resulting data at a pre-specified destination. Advantageously, the DMA engine may be implemented in an environment allowing for out of order completion of the data transfer requests, such as an environment including a peripheral component interconnect extended (PCI-X) bus.

The pipelined circuit of the present invention may provide the multi-threaded DMA engine with tags for transactions. In this manner, the number of DMA threads created and executed by the DMA engine may not exceed the number of stages in the pipelined circuit. In an embodiment of the invention, the DMA engine may be coupled to an interface such as a fibre channel interface, a small computer system interface (SCSI), or the like, for moving data between the PCI-X bus and the fibre channel/SCSI.

It is to be understood that both the foregoing general description and the following detailed description are exemplary and explanatory only and are not necessarily restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1A is a circuit diagram illustrating a pipelined circuit for supplying a tag to a DMA thread in accordance with an exemplary embodiment of the present invention;

FIG. 1B is a block diagram of the pipelined circuit illustrated in FIG. 1, wherein the pipelined circuit is coupled to a DMA engine and a PCI-X bus in accordance with an exemplary embodiment of the present invention; and

FIG. 2 is a flow diagram illustrating a method for providing a tag to a DMA thread in accordance with an exemplary embodiment of the present invention.

### DETAILED DESCRIPTION OF THE INVENTION

Reference will now be made in detail to the presently preferred embodiments of the invention, examples of which are illustrated in the accompanying drawings.

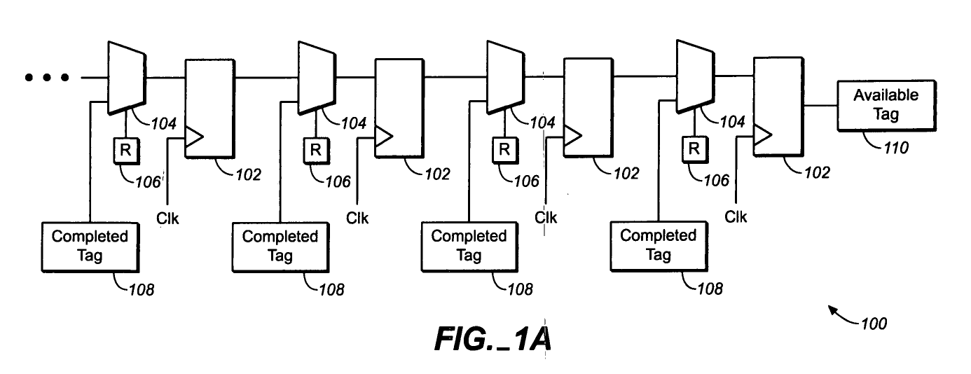

Referring to FIG. 1, a pipelined circuit 100 is described in accordance with an exemplary embodiment of the present invention. The pipelined circuit includes registers 102 for providing a tag to a direct memory access (DMA) thread and receiving the tag upon completion of the DMA thread. In an embodiment of the invention, a DMA engine 103 is programmed to automatically fetch and store data to memory addresses specified by a data structure. For example, an embedded processor programs the DMA engine 103 with the starting address of a data structure. Then, the DMA engine fetches the data structure, processes it, and determines whether to retrieve data or push data from one of several transfer interfaces. In the case of a DMA engine 103 which is executed in a multi-threaded DMA environment, the DMA engine may generate multiple transfer requests, process them in any order, and then reassemble the resulting data at a pre-specified destination.

In such an instance, the DMA engine 103 may be implemented in an environment allowing for out of order completion of the data transfer requests, such as an environment including a peripheral component interconnect extended (PCI-X) bus 107, or the like. DMA engine 103 may be connected to an interface 109, such as a fibre channel interface, a small computer system interface (SCSI), or the like, for moving data between the PCI-X bus 107 and the fibre channel/SCSI 109. Those of skill in the art will appreciate that use of the PCI-X bus 107 in combination with the multi-threaded DMA environment may result in an amelioration of data throughput. It should be noted that while the multi-threaded DMA environment described herein includes the PCI-X bus 107, the use of other interconnect technologies including outstanding transaction capability would not depart from the scope and intent of the present invention.

The pipelined circuit 100 may provide the multi-threaded DMA engine 103 with tags for transactions. For example, when a first DMA thread is generated by the DMA engine 103, it may be issued a first tag. When a second DMA thread is generated, it may be issued a second tag. When the first and second tags are issued, the remaining tags in the pipeline may shift, leaving two stages of the pipeline invalid. However, upon completion of one of the first and second DMA threads, the first or second tag associated with the completed thread is returned to the pipeline and requeued. Then, only one stage in the pipeline is invalid. In this manner, the number of DMA threads created and executed by the DMA engine 103 may not exceed the number of stages in the pipelined circuit 100. For instance, in one specific embodiment, as illustrated in FIG. 1, the pipelined circuit 100 contains four stages. In this manner, no more than four separate DMA threads may be executed by the DMA engine 103 at a given time. However, those of skill in the art will appreciate that more or fewer stages may be employed in the pipelined circuit 100 of the present invention without departing from the scope and intent of the present invention.

The pipelined circuit 100 may include a multiplexer 104 coupled to the register 102, for receiving a signal 106 directing the register 102 to requeue a completed tag 108. In an embodiment of the invention, the multiplexer 104 allows the pipelined circuit 100 to present an available tag 110 to a DMA thread. For instance, the DMA thread may select the available tag 110 before execution, returning the completed tag 108 to the pipelined circuit 100 upon completion. Those of skill in the art will appreciate that various other circuits may be utilized with the pipelined circuit 100 of the present invention. For example, in one embodiment, a counter of available tags may be used, while in another embodiment, the pipelined circuit 100 may be implemented in software, firmware, or the like. Those of skill in the art will appreciate that a tag may be assigned a numerical value for utilization by a DMA thread in determining an offset for a memory location to which data is transferred. For instance, a DMA thread may determine an offset memory location based on a tag having a numerical value of two. This offset may be two data blocks away from the starting address of the data block. In another embodiment, each DMA thread is assigned an offset when it is created; thus, the numerical value of the tag in this instance may be utilized solely for identifying the tag to the pipelined circuit 100.

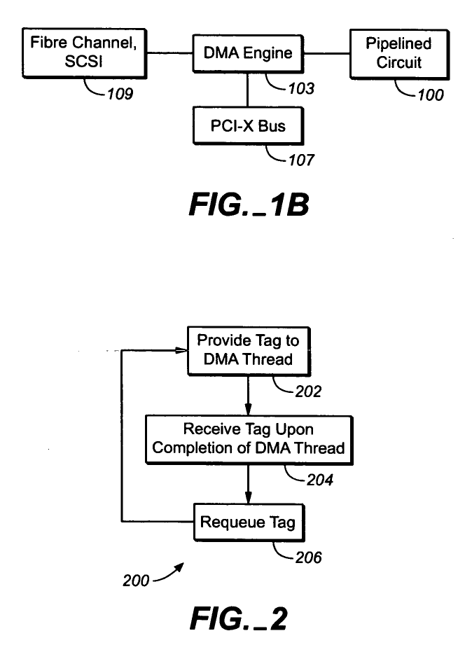

Referring now to FIG. 2, a method 200 for providing a direct memory access (DMA) thread with a tag is described in accordance with an exemplary embodiment of the present invention. First, the tag is provided to the DMA thread by a pipelined circuit or the like, 202. For example, the pipelined circuit includes registers and multiplexers for providing the tag to the DMA thread. When the tag is issued, the remaining tags in the pipeline may shift, leaving a stage of the pipeline invalid. Next, the tag is received by the pipelined circuit upon completion of the DMA thread, 204. Thus, the tag associated with the completed thread is returned to the pipeline. Finally, the tag is requeued upon completion of the DMA thread, 206. Then, one less stage in the pipeline is invalid. Subsequently, the tag is provided to another DMA thread, 202. In this manner, the number of DMA threads created and executed by the DMA engine may not exceed the number of stages in the pipelined circuit.

It is believed that the present invention and many of its attendant advantages will be understood by the foregoing description, and it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A pipelined circuit for providing a first direct memory access (DMA) thread and a second DMA thread with a tag, comprising:
a plurality of registers for providing a tag to a first DMA thread and receiving the tag upon completion of the first DMA thread,
wherein the pipelined circuit requeues the tag in the plurality of registers upon completion of the first DMA thread for providing the tag to a second DMA thread.

2. The pipelined circuit as claimed in claim 1, further comprising a multiplexer coupled to a register of the plurality of registers

3. The pipelined circuit as claimed in claim 1, wherein the multiplexer receives a signal directing the plurality of registers to requeue the tag.

4. The pipelined circuit as claimed in claim 1, wherein the tag is for indicating DMA thread availability to a DMA engine.

5. A system for providing a first direct memory access (DMA) thread and a second DMA thread with a tag, comprising:
a plurality of registers connected in an electrical circuit for providing the tag to the first DMA thread and receiving the tag upon completion of the first DMA thread,
wherein the electrical circuit requeues the tag in the plurality of registers upon completion of the first DMA thread for providing the tag to a second DMA thread.

6. The system as claimed in claim 5, further comprising a multiplexer coupled to a register of the plurality of registers.

7. The system as claimed in claim 6, wherein the multiplexer receives a signal directing the plurality of registers to requeue the tag.

8. The system as claimed in claim 5, further comprising a DMA engine coupled to said plurality of registers.

9. The system as claimed in claim 8, wherein the DMA engine is configured for fetching data from a first memory address and storing the data at a second memory address, one or more of the first and second memory addresses being specified by a data structure.

10. The system as claimed in claim 9, wherein the DMA engine is capable of multi-threaded DMA activity.

11. The system as claimed in claim 10, wherein the tag is for indicating DMA thread availability to a DMA engine.

12. The system as claimed in claim 10, further comprising a peripheral component interconnect extended (PCI-X) bus coupled to said DMA engine.

13. The system as claimed in claim 10, further comprising at least one of a fibre channel and a small computer system interface (SCSI) coupled to said DMA engine.

14. A system for providing a first direct memory access (DMA) thread and a second DMA thread with a tag, comprising:
a plurality of registers connected in an electrical circuit for providing the tag to the first DMA thread and receiving the tag upon completion of the first DMA thread,
a multiplexer coupled to a register of the plurality of registers; and
a DMA engine coupled to said plurality of registers,
wherein the electrical circuit requeues the tag in the plurality of registers upon completion of the first DMA thread for providing the tag to a second DMA thread.

15. The system as claimed in claim 6, wherein the multiplexer receives a signal directing the plurality of registers to requeue the tag.

16. The system as claimed in claim 14, wherein the DMA engine is configured for fetching data from a first memory address and storing the data at a second memory address, one or more of the first and second memory addresses being specified by a data structure.

17. The system as claimed in claim 16, wherein the DMA engine is capable of multi-threaded DMA activity.

18. The system as claimed in claim 17, wherein the tag is for indicating DMA thread availability to a DMA engine.

19. The system as claimed in claim 17, further comprising a peripheral component interconnect extended (PCI-X) bus coupled to said DMA engine.

20. The system as claimed in claim 17, further comprising at least one of a fibre channel and a small computer system interface (SCSI) coupled to said DMA engine.

21. A method for providing a first direct memory access (DMA) thread and a second DMA thread with a tag, comprising:
providing the tag to the first DMA thread;
receiving the tag upon completion of the first DMA thread; and
requeuing the tag upon completion of the first DMA thread,
wherein the tag is subsequently provided to a second DMA thread.

22. The method as claimed in claim 21, wherein the tag is for indicating DMA thread availability to a DMA engine.
